(19) United States
(12) Patent Application Publication
(10) Pub. No.: US 2006/0047880 A1
(43) Pub. Date: Mar. 2, 2006

(54) Memory device with HUB capability

(75) Inventors: Steven L. Lindblom, Inver Grove Heights, MN (US); Trung V. Le, White Bear Township, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/928,488

(22) Filed: Aug. 27, 2004

(51) Int. Cl. G06F 12/14; G06F 13/14

(52) U.S. Cl. 710/305; 711/115

(57) ABSTRACT

A memory device is described that integrates the functionality of a single port hub into a conventional memory device. The memory device includes a host connector that allows a host computer access to a memory within the memory device. The memory device also includes a device socket that allows the host computer access to a device connected to the device socket. A hub within the memory device electrically couples the host connector to the memory as well as to the device socket. The memory device allows the device to be coupled to the host computer via the device socket while the memory device is coupled to the host computer via the host connector. The hub presents the memory device and the device coupled to the memory device to the host computer as separate and independent devices. In that way, a user may use both devices via a single host connector interface of a host computer.

### TECHNICAL FIELD

The invention relates to removable storage media devices and, in particular, removable memory drives.

### BACKGROUND

A wide variety of removable storage media exists for transferring data from one device to another device. The removable storage media allows users to easily transport data between various devices and various computers. One of the most popular types of removable storage media is the flash memory drive, which is compact, easy to use, and has no moving parts. A flash memory drive includes an internal, high-speed solid-state memory capable of persistently storing data without application of power.

Numerous other memory standards can also be used in memory drives, including electrically-erasable-programmable-read-only-memory (EEPROM), non-volatile random-access-memory (NVRAM), and other non-volatile or volatile memory types, such as synchronous dynamic random-access-memory (SDRAM), with battery backup. A wide variety of memory drives have been recently introduced, each having different capacities, access speeds, formats, interfaces, and connectors.

Memory drives generally include a specialized connector for coupling to a computing device. For example, a memory drive connector may couple to a host computer via a host computer interface, such as a personal computer memory card international association (PCMCIA) interface including a 16 bit standard PC Card interface and a 32 bit standard CardBus interface, a Universal Serial Bus (USB) interface, a Universal Serial Bus 2 (USB2) interface, a future generation USB interface, an IEEE 1394 FireWire interface, a Small Computer System Interface (SCSI) interface, an Advance Technology Attachment (ATA) interface, a serial ATA interface, an Integrated Device Electronic (IDE) interface, an Enhanced Integrated Device Electronic (EIDE) interface, a Peripheral Component Interconnect (PCI) interface, a PCI Express interface, a conventional serial or parallel interface, or the like.

Most computing devices have only one host computer interface compatible with a specialized connector of a memory drive. Therefore, if another device, such as a mouse or a keyboard, is using the host computer interface, a user must remove the device in order to use the memory drive.

### SUMMARY

In general, the invention is directed to a memory device that integrates the functionality of a hub into a conventional memory device. The memory device includes a host connector that allows a host computer access to a memory within the memory device. The memory device also includes a device socket that allows the host computer to access a device connected to the device socket of the memory device. A hub, within the memory device, electrically couples the host connector to the device socket. In some embodiments, the hub also electrically couples the host connector to the memory.

A host computer may include only one host computer interface compatible with a specific host connection standard to which both the memory device and another device conform. In that case, the memory device can allow another device to be coupled to the host computer via the device socket while the memory device is coupled also to the host computer via the host connector. The hub within the memory device presents the memory device and the other device coupled to the memory device to the host computer as separate and independent devices. In that way, a user may use both devices simultaneously.

In one embodiment, the invention is directed to a memory device comprising a memory, a hub, a host connector, and a device socket. The hub electrically couples to the memory. The host connector electrically couples to the hub and allows access to the memory upon insertion of the host connector into a host computer interface. The device socket electrically couples to the hub and allows access to a device upon insertion of a connector included in the device into the device socket.

In another embodiment, the invention is directed to a system comprising a host computer including a host computer interface, a device including a connector, and a memory device. The memory device includes a memory, a hub, a host connector, and a device socket. The hub electrically couples to the memory. The host connector electrically couples to the hub and allows access to the memory upon insertion of the host connector into the host computer interface of the host computer. The device socket electrically couples to the hub and allows access to the device upon insertion of the connector of the device into the device socket of the memory device. In this way, the host computer can access the memory of the memory device, and can also utilize the device coupled to the device socket of the memory device by sending and/or receiving signals from the device through the memory device.

In another embodiment, the invention is directed to a method comprising receiving an amount of power from a host computer to enable operation of a memory device upon insertion of a host connector of the memory device into a host computer interface of the host computer. The method further comprises allowing access to a memory within the memory device via the host computer upon insertion of the host connector into the host computer interface. The method also includes allowing access to another device by the host computer through the memory device upon insertion of a connector of the another device into a device socket of the memory device.

In some cases, the method may additionally include requesting an amount of power from a host computer to enable operation of the memory device and the another device coupled to the memory device, and triggering an indicator included in the memory device when an amount of power received from the host computer is insufficient to power both the memory device and the another device coupled to the memory device. The request for power may comprise an arbitration process between the memory device and the host computer. If enough power is granted to the memory device to operate both the memory device and the additional device coupled to the device socket of the memory device, both devices can function. If additional power sufficient to operate both devices is not granted, the memory device may disable its device socket and trigger the indicator to alert the user of the lack of power sufficient to power the additional device.

The invention is capable of providing many advantages. For example, the memory device with hub capability described herein allows other peripheral devices to be coupled to a host computer while the memory device is occupying the host computer interface. The peripheral devices may include a mouse, a keyboard, a joystick, a scanner, a printer, a game controller, a docking station for a handheld computer, a portable digital assistant (PDA), a digital still camera, a digital video camera, a cell phone, another hub, a digital music player, or a digital multimedia player. The invention achieves greater flexibility in connecting devices to a single host computer interface. This may be especially useful on laptop computers where size constraints limit the number of ports that may be available. In addition, the memory device can allow simultaneous access to multiple memory drives. In this case, a user can swap data between memory drives without having to disconnect one drive and reconnect another drive.

Furthermore, an indicator, such as a light emitting diode (LED), may be included in the memory device to show when devices connected to the device socket of the memory device are attempting to draw too much power. The indicator notifies a user that some or all of the devices connected downstream of the memory device will not operate properly. The user may then change the connected devices as required for proper functionality. The indicator alerts the user of an insufficient power problem before the user attempts to use an underpowered device.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a memory device according to an embodiment of the invention.

FIG. 2 is a block diagram illustrating another memory device according to an embodiment of the invention.

FIGS. 3A and 3B are schematic diagrams illustrating an exemplary embodiment of a memory device.

FIG. 4 is a schematic diagram illustrating an exemplary system of two memory devices coupled to a host computer.

FIG. 5 is a schematic diagram illustrating an exemplary system of a memory device and an input device coupled to a host computer.

FIG. 6 is a block diagram illustrating a memory device according to another embodiment of the invention.

FIG. 7 is a schematic diagram illustrating an exemplary embodiment of a memory device.

FIG. 8 is a flow chart illustrating an exemplary method of enabling a memory device with hub capability.

### DETAILED DESCRIPTION

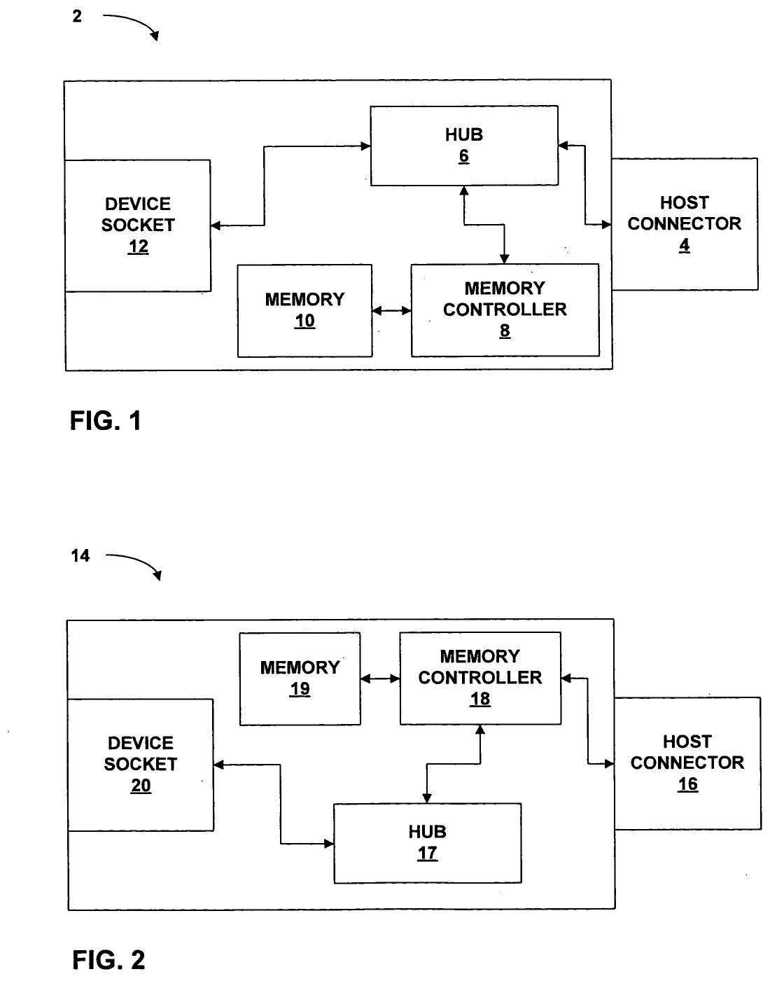

FIG. 1 is a block diagram illustrating a memory device 2 according to an embodiment of the invention. Memory device 2 includes a host connector 4, a hub 6, a memory controller 8, a memory 10, and a device socket 12. Memory device 2 couples to a host computer via host connector 4 and provides device socket 12 for a device to also couple to the host computer through memory device 2. The device may comprise a mouse, a keyboard, a joystick, a scanner, a printer, a game controller, a docking station for a handheld computer, a portable digital assistant (PDA), a digital still camera, a digital video camera, a cell phone, another hub, a digital music player, a digital multimedia player, or a memory drive. In the illustrated embodiment, memory device 2 integrates the functionality of a dual port hub into a conventional memory device. As shown in FIG. 1, one port of hub 6 comprises device socket 12 and the other port of hub 6 is permanently connected to memory device 2.

As an example, a host computer may include only one host computer interface compatible with a specific host connection standard to which host connector 4 conforms. Therefore, if a device that includes a connector also conforming to the host connection standard is using the host computer interface, a user of the host computer must remove the device in order to use a conventional memory device. However, memory device 2 allows the device to be coupled to the host computer via device socket 12 while memory device 2 is coupled to the host computer via host connector 4. Thus, the host computer can utilize the device coupled to device socket 12 of memory device 2 by sending and/or receiving signals from the device coupled to device socket 12 through memory device 2.

Host connector 4 allows access to memory 10 by a host computer (not shown) upon insertion of host connector 4 into a host computer interface included in the host computer. Host connector 4 is electrically coupled to memory 10 via hub 6 and memory controller 8. Host connector 4 conforms to a host connection standard and the host computer interface is compatible with the host connection standard. The host connection standard may comprise a personal computer memory card international association (PCMCIA) standard including a 16 bit standard PC Card and a 32 bit standard CardBus, a Universal Serial Bus (USB) standard, a Universal Serial Bus 2 (USB2) standard, a future generation USB standard, an IEEE 1394 FireWire standard, a Small Computer System Interface (SCSI) standard, an Advance Technology Attachment (ATA) standard, a serial ATA standard, an Integrated Device Electronic (IDE) standard, an Enhanced Integrated Device Electronic (EIDE) standard, a Peripheral Component Interconnect (PCI) standard, a PCI Express standard, a conventional serial or parallel standard, or the like.

Device socket 12 allows access to another device (not shown) by the host computer upon insertion of a connector included in the another device into device socket 12 of memory device 2. Device socket 12 is electrically coupled to host connector 4 via hub 6. Device socket 12 is compatible with a connection standard and the connector of the additional device conforms to the connection standard. In some embodiments, device socket 12 is compatible with the host connection standard to which host connector 4 conforms.

By way of example, memory 10 may comprise flash memory, electrically-erasable-programmable-read-only-memory (EEPROM), non-volatile random-access-memory (NVRAM), and other nonvolatile or volatile memory types, such as synchronous dynamic random-access-memory (SDRAM), with battery backup, or the like.

Once memory device 2 is coupled to a host computer via host connector 4, power is delivered through host connector 4 to enable memory device 2. Once enabled, hub 6 allows the host computer access to memory controller 8 and memory 10. Communication between the host computer and memory controller 8 may then be sent through powered host connector 4. The host computer may read or modify data that is stored in memory 10 as well as store new data or erase existing data. Memory controller 8 manipulates the data stored in memory 10 according to operations specified by the host computer.

In the case where a device is coupled to memory device 2 via device socket 12, hub 6 requests additional power from the host computer to enable operation of the device. If an amount of power received from the host computer is insufficient to power both memory device 2 and the device coupled to memory device 2, hub 6 may disable device socket 12. In some embodiments, hub 6 triggers an indicator (not shown) when the received power is insufficient to power both the memory device and the additional device coupled to device socket 12. If an amount of power received from the host computer is sufficient to power both memory device 2 and the device coupled to memory device 2, device socket 12 allows the host computer access to the device through memory device 2.

Hub 6 presents memory device 2 to the host computer. When another device is coupled to memory device 2 via device socket 12, hub 6 also presents the other device to the host computer. In this way, coupling a device to memory device 2 allows the two devices to be connected, and can allow independent operation of the devices. A user of the host computer may choose to operate either memory device 2 or the device coupled to memory device 2. The user may also operate both devices at the same time.

As an example, a host computer may include only one available USB port. The host computer may include a USB mouse plugged into the USB port. In an embodiment where host connector 4 conforms to a USB connector and device socket 12 is compatible with a USB standard, memory device 2 allows the USB mouse to be coupled to the host computer through device socket 12 and host connector 4 while memory device 2 is in use. In that way, a user may continue to use the USB mouse as an input device of the host computer while reading data from memory device 2 and/or storing data on memory device 2.

Furthermore, another memory device substantially similar to memory device 2 may be coupled to memory device 2 via device socket 12. In that way, a user may simultaneously access memory 10 of memory device 2 as well as a memory within the other memory device. The user may then swap data between the memory devices without having to disconnect one of the memory devices and reconnect the other memory device. Any number of memory devices 2 may be coupled to one another as long as sufficient power is available.

In some embodiments, memory device 2 requires approximately 100 mA from the host computer to operate properly. Typically, a host computer interface included in a host computer provides approximately 100 mA as a default upon insertion of a host connector to the host computer interface, consistent with the USB standard. Therefore, a sufficient amount of power is automatically supplied to enable memory device 2.

However, when a device is connected to device socket 12, hub 6 can arbitrate with the host computer for additional power. Typically, the host computer can allocate a maximum of 500 mA to the host computer interface, consistent with the USB standard. If the device coupled to memory device 2 requires more than 400 mA to operate properly, the arbitration will fail. In that case, hub 6 may trigger an indicator to alert a user that too much power is being requested from the host computer interface. Furthermore, hub 6 may disable device socket 12 so the user does not attempt to operate the underpowered device coupled to the memory device 2.

In addition, each of a plurality of memory devices substantially similar to memory device 2 may be coupled to the host computer via the device socket included in the preceding memory device. In that case, the hub included in the first memory device arbitrates with the host computer to receive a sufficient amount of power to operate the subsequent memory devices connected downstream. If the host computer allocates 500 mA to the first memory device, up to four additional memory devices may be powered with the fifth device socket being disabled.

FIG. 2 is a block diagram illustrating another memory device 14 according to an embodiment of the invention. Memory device 14 includes a host connector 16, a hub 17, a memory controller 18, a memory 19, and a device socket 20. Memory device 14 couples to a host computer via host connector 16 and provides device socket 20 for a device, such as a mouse, a keyboard, or another memory device, to also couple to the host computer through memory device 14. In the illustrated embodiment, memory device 14 integrates the functionality of a single port hub into a conventional memory device.

Memory device 14 operates substantially similar to memory device 2 from FIG. 1. However, in the embodiment illustrated in FIG. 2, the host connector is not coupled directly to the hub. Instead the host connector is electrically coupled to the hub via the memory controller. Memory device 14 allows a device to be coupled to a host computer via device socket 20 while memory device 14 is coupled to the host computer via host connector 16. Host connector 16 allows access to memory 19 by a host computer (not shown) upon insertion of host connector 16 into a host computer interface included in the host computer. Host connector 16 is electrically coupled to memory 19 via memory controller 18. Host connector 16 conforms to a host connection standard and the host computer interface is compatible with the host connection standard.

Device socket 20 allows access to another device (not shown) by the host computer upon insertion of a connector included in the another device into device socket 20 of memory device 14. Device socket 20 is electrically coupled to host connector 16 via hub 17 and memory controller 18. Device socket 20 is compatible with a connection standard and the connector of the additional device conforms to the connection standard. In some embodiments, device socket 20 is compatible with the host connection standard to which host connector 16 conforms.

Once memory device 14 is coupled to a host computer via host connector 16, power is delivered through host connector 16 to enable memory device 14. Once enabled, memory controller 18 allows the host computer access to memory 19 and hub 17. Communication between the host computer and memory controller 18 may then be sent through powered host connector 16. The host computer may read or modify data that is stored in memory 19 as well as store new data or erase existing data. Memory controller 18 manipulates the data stored in memory 19 according to operations specified by the host computer.

In the case where a device is coupled to memory device 14 via device socket 20, hub 17 requests additional power from the host computer to enable operation of the device. If an amount of power received from the host computer is insufficient to power both memory device 14 and the device coupled to memory device 14, hub 17 may disable device socket 20. In some embodiments, hub 17 triggers an indicator (not shown) when the received power is insufficient to power both the memory device and the additional device coupled to device socket 20. If an amount of power received from the host computer is sufficient to power both memory device 14 and the device coupled to memory device 14, device socket 20 allows the host computer access to the device through memory device 14.

Hub 17 presents memory device 14 to the host computer. When another device is coupled to memory device 14 via device socket 20, hub 17 also presents the other device to the host computer. In this way, coupling a device to memory device 14 allows the two devices to be connected, and can allow independent operation of the devices. A user of the host computer may choose to operate either memory device 14 or the device coupled to memory device 14. The user may also operate both devices at the same time.

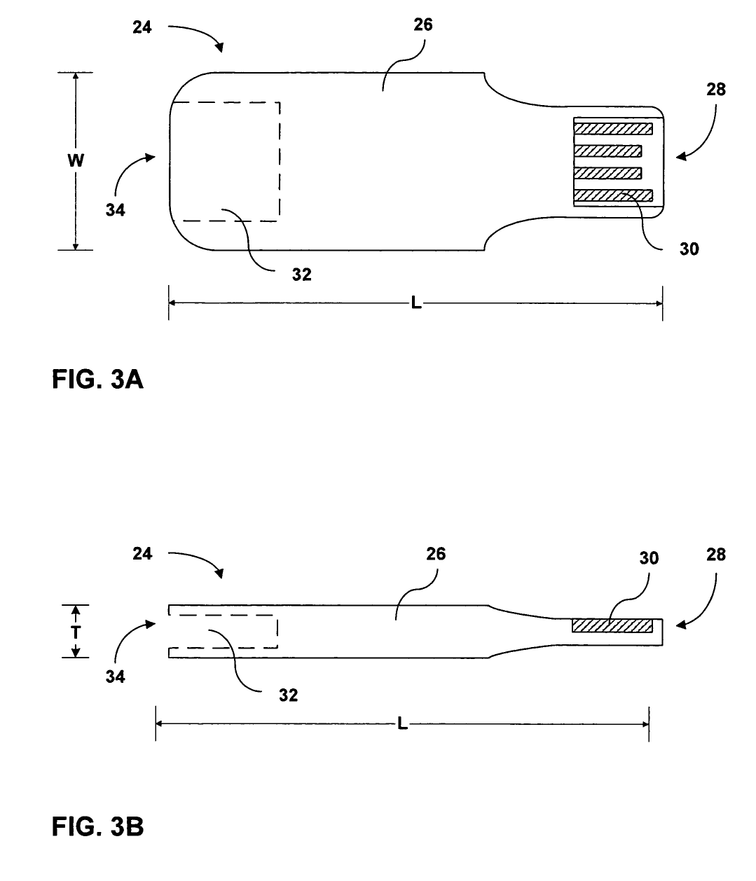

FIGS. 3A and 3B are schematic diagrams illustrating an exemplary embodiment of a memory device 24. Memory device 24 comprises a memory device housing 26, a host connector 28, host connector contacts 30 disposed on host connector 28, a cavity 32 formed in memory device housing 26, and a device socket 34 disposed within cavity 32. FIG. 3A shows a top view of memory device 24, while FIG. 3B shows a side view of memory device 24. In the embodiment shown in FIGS. 3A and 3B, host connector 28 conforms to a USB plug and device socket 34 conforms to a USB receptacle. The USB plug may be a conventional USB plug that includes a shield or may comprise a shieldless tab that eliminates the shield to reduce the form factor of host connector 28. In other embodiments, host connector 28 and device socket 34 may conform to meet other host connection standards, such as one of the standards listed above or possibly another standard yet developed.

Memory device 24 operates substantially similar to memory device 2 from FIG. 1. Memory device 24 may be connected to a host computer by inserting host connector 28 into a host computer interface included in the host computer. Host connector contacts 30 couple to contacts included in the host computer interface to allow power and data to flow between memory device 24 and the host computer. For USB, host connector contacts 30 may include a power contact, a ground contact, a positive data signal contact and a negative data signal contact.

A device, such as a mouse, a keyboard, or another memory device, may be connected to the host computer by inserting a connector included in the device to device socket 34 of memory device 24. Device socket 34 includes device socket contacts that couple to connector contacts disposed on the connector of the device. A hub (not shown) included in memory device 24 routes power and data between device socket 34 and the host computer.

In the embodiment illustrated in FIGS. 3A and 3B, memory device 24 comprises a memory drive, such as a flash memory drive. A flash memory drive includes an internal, high-speed solid-state memory capable of persistently storing data without application of power. In addition, flash memory drives are compact, easy to use, and have no moving parts. In the case where memory device 24 comprises a flash memory drive, memory device housing 26 may conform to a flash memory drive form factor. For example, the flash memory drive form factor may include a length L between 35 mm and 80 mm, a width W between 12 mm and 50 mm, and a thickness T between 4 mm and 20 mm. However, the invention is not limited to a flash memory drive form factor and may have other dimensions.

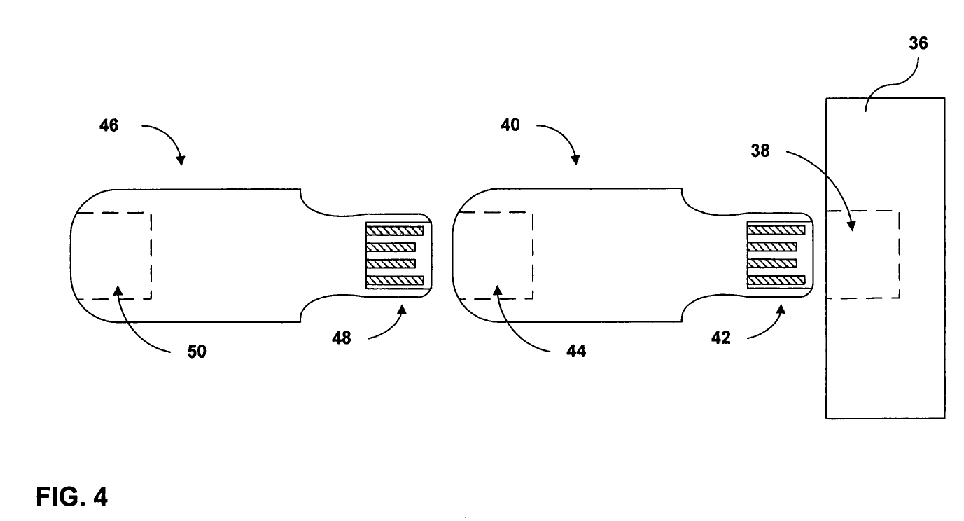

FIG. 4 is a schematic diagram illustrating an exemplary system of two memory devices 40, 46 coupled to a host computer 36. Host computer 36 includes a host computer interface 38. Host computer interface 38 is compatible with a host connection standard, e.g., USB or USB2. A first memory device 40 includes a first host connector 42 and a first device socket 44. A second memory device 46 includes a second host connector 48 and a second device socket 50. First and second memory devices 40, 46 operate substantially similar to memory device 2 described in reference to FIG. 1.

First memory device 40 couples to host computer 36 by inserting first host connector 42 into host computer interface 38. First host connector 42 conforms to the host connection standard with which host computer interface 38 is compatible. First host connector 42 provides host computer 36 access to a first memory included within first memory device 40. First memory device 40 also includes a first hub, which electrically couples first host connector 42 to the first memory and to first device socket 44. First device socket 44 is compatible with another host connection standard. In some embodiments, first device socket 44 may be compatible with the same host connection standard to which first host connector 42 conforms.

Second memory device 46 couples to host computer 36 via first memory device 40 by inserting second host connector 48 into first device socket 44. Second host connector 48 conforms to the host connection standard with which first device socket 44 is compatible. Second host connector 48 provides host computer 36 access to a second memory included within second memory device 46 via first device socket 44. In other words, host computer 36 accesses second memory device 46 through first memory device 40. Second memory device 46 also includes a second hub, which electrically couples second host connector 48 to the second memory and to second device socket 50.

The first hub of first memory device 40 presents both the first memory of first memory device 40 and the second memory of second memory device 46 to host computer 36. A user of host computer 36 may use first and second memory devices 40 and 46 as separate and independent devices. For example, a user may swap data between the first memory of first memory device 40 and the second memory of second memory device 46 without disconnecting first memory device 40 and reconnecting second memory device 46.

In some embodiments, a device, such as a mouse, a keyboard, or a conventional memory drive, may be coupled to host computer 36 via second device socket 50. In other embodiments, a third memory device substantially similar to first and second memory devices 40 and 46 may be coupled to host computer 36 via second device socket 50. Any number of memory devices substantially similar to first and second memory devices 40 and 46 may be coupled together as illustrated in FIG. 4, as long as the memory devices do not collectively exceed the power granted through host computer interface 38.

As an example, host computer 36 provides first memory device 40 approximately 100 mA as a default upon insertion of first host connector 42 to host computer interface 38. First memory device 40 requires approximately 100 mA to operate. However, when second host connector 48 is inserted in first device socket 44, the first hub within first memory device 40 must arbitrate with host computer 36 to receive additional power to enable second memory device 46.

First memory device 40 may receive an additional 400 mA from host computer 36 upon successful arbitration with the first hub. Second memory device 46 also requires approximately 100 mA to operate. Therefore, both first and second memory devices 40 and 46 may be enabled, and the additional 300 mA may be made available at second device socket 50. In that case, a third, fourth, and fifth memory device may be coupled to memory device 36 via the device socket included in each preceding memory device. However, enough power is not available to enable a sixth device inserted in the fifth device socket of the fifth memory device. A fifth hub located in the fifth memory device may trigger a power indicator also included in the fifth memory device to alert a user that an insufficient amount of power is available at the fifth device socket. Furthermore, the fifth hub may disable the fifth device socket so the user does not attempt to operate an under powered device inserted in the fifth socket.

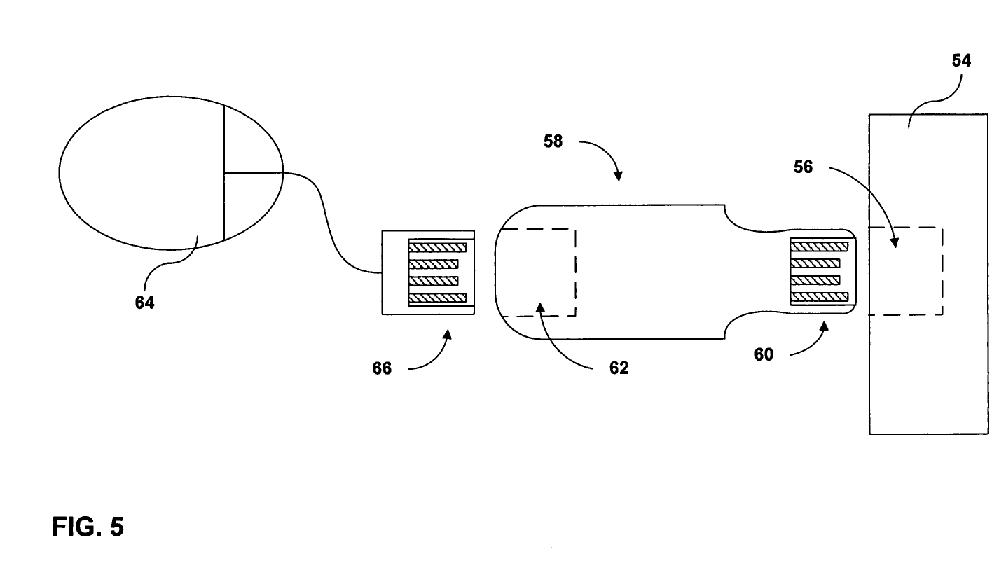

FIG. 5 is a schematic diagram illustrating an exemplary system of a memory device 58 and an input device 64 coupled to a host computer 54. Host computer 54 includes a host computer interface 56. Host computer interface 56 is compatible with a host connection standard, e.g., USB or USB2. A memory device 58 includes a first host connector 60 and a device socket 62. An input device 64 includes a second host connector 66. In the illustrated embodiment, input device 64 comprises a mouse, although the same principles can apply to other input devices such as a keyboard, a joystick, a scanner, a printer, a game controller, a docking station for a handheld computer, a portable digital assistant (PDA), a digital still camera, a digital video camera, a cell phone, another hub, a digital music player, a digital multimedia player, or any input device that includes a connector that conforms to the standard of device socket 62. Moreover, other devices that may be coupled to the host computer through the memory device in accordance with the invention may include printers, scanners, game controllers, docking stations for handheld computers, or a wide variety of other peripheral devices. In any case, memory device 58 operates substantially similar to memory device 2 described in reference to FIG. 1.

Memory device 58 couples to host computer 54 by inserting first host connector 60 into host computer interface 56. First host connector 60 conforms to the host connection standard with which host computer interface 56 is compatible. First host connector 60 provides host computer 54 access to a memory included within memory device 58. Memory device 58 also includes a hub, which electrically couples first host connector 60 to the memory and to device socket 62. Device socket 62 is compatible with a host connection standard. In some embodiments, device socket 62 may be compatible with the same host connection standard to which first host connector 60 conforms.

Input device 64 couples to host computer 54 via memory device 58 by inserting second host connector 66 into first device socket 62. Second host connector 66 conforms to the host connection standard with which first device socket 62 is compatible. Second host connector 66 provides host computer 54 access to input device 64 via first device socket 62. Input device 64 and memory device 58 may operate simultaneously.

In other embodiments, any type of device may be coupled to host computer 54 via device socket 62, as illustrated in FIG. 5, as long as the device does not exceed a power limitation of host computer interface 56. Again, for example, host computer 54 may provide memory device 58 with approximately 100 mA as a default upon insertion of first host connector 60 to host computer interface 56. If memory device 58 requires approximately 100 mA to operate, the default will be sufficient initially. However, when second host connector 66 is inserted in device socket 62, the hub within memory device 58 may arbitrate with host computer 54 to receive additional power to enable input device 64.

Memory device 58 may receive an up to an additional 400 mA from host computer 54 upon successful arbitration with the hub. Input device 64 may require at least 100 mA to operate. If input device 64 requires less than 400 mA to operate properly, both memory device 58 and input device 64 may be enabled. If input device 64 requires more than 400 mA to operate properly, the arbitration between host computer 54 and the hub within memory device 58 will fail. In that case, the hub may trigger an indicator also included in memory device 58 to alert a user that input device 64 requires more power than is available at host computer interface 56. Furthermore, the hub may disable device socket 62 so the user does not attempt to operate underpowered input device 64 inserted in device socket 62.

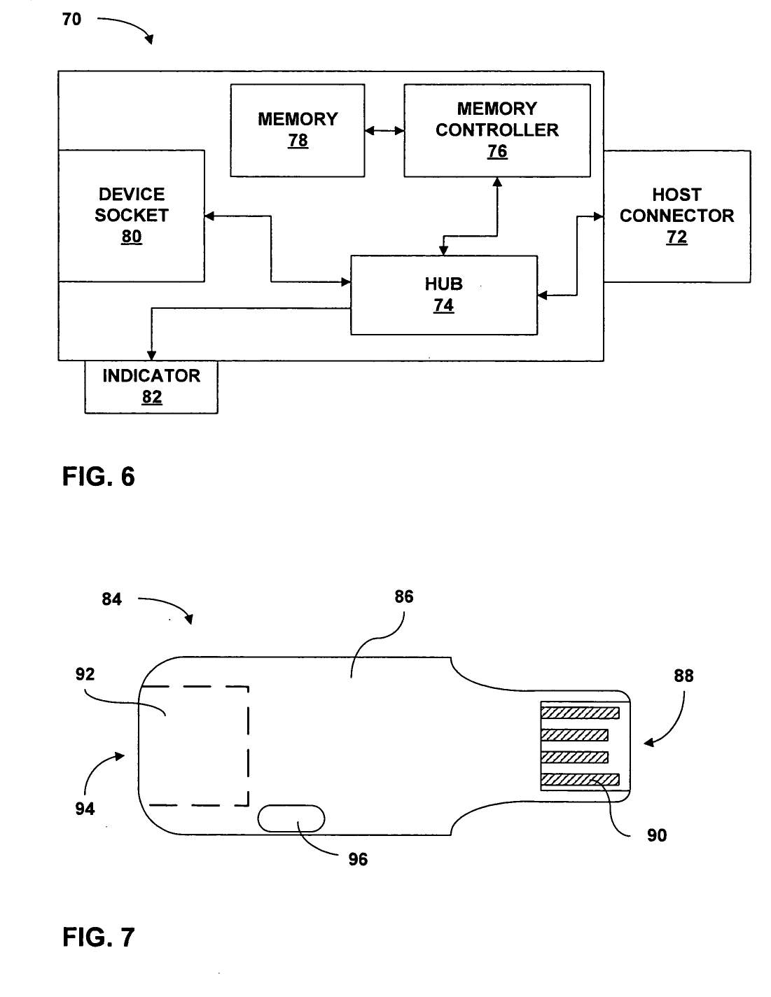

FIG. 6 is a block diagram illustrating a memory device 70 according to another embodiment of the invention. Memory device 70 includes a host connector 72, a hub 74, a memory controller 76, a memory 78, a device socket 80, and an indicator 82. Memory device 70 operates substantially similar to memory device 2 illustrated in FIG. 1. Memory device 70 couples to a host computer via host connector 72 and provides device socket 80 for a device to also couple to the host computer through memory device 70. The device may comprise a mouse, a keyboard, a joystick, a scanner, a printer, a game controller, a docking station for a handheld computer, a portable digital assistant (PDA), a digital still camera, a digital video camera, a cell phone, another hub, a digital music player, a digital multimedia player, or a memory drive. In the illustrated embodiment, memory device 70 integrates the functionality of a dual port hub into a conventional memory device. In other embodiments, a memory device that operates substantially similar to memory device 14 illustrated in FIG. 2 may include an indicator 82. In that embodiment, the memory device integrates the functionality of a single port hub into a conventional memory device.

Host connector 72 allows access to memory 78 by a host computer (not shown) upon insertion of host connector 72 into a host computer interface included in the host computer. Host connector 72 is electrically coupled to memory 78 via hub 74 and memory controller 76. Host connector 72 conforms to a host connection standard and the host computer interface is compatible with the host connection standard.

Device socket 80 allows access to a device (not shown) by the host computer upon insertion of a connector included in the device into device socket 80. Device socket 80 is electrically coupled to the host connector via hub 74. Device socket 80 is compatible with a connection standard and the connector of the device conforms to the connection standard. In some embodiments, device socket 80 is compatible with the host connection standard to which host connector 72 conforms.

By way of example, memory 78 may comprise flash memory, electrically-erasable-programmable-read-only-memory (EEPROM), non-volatile random-access-memory (NVRAM), and other nonvolatile or volatile memory types, such as synchronous dynamic random-access-memory (SDRAM), with battery backup, or the like.

Once memory device 70 is coupled to a host computer via host connector 72, power is delivered through host connector 72 to enable memory device 70. Once enabled, hub 74 allows the host computer access to memory controller 76 and memory 78. Communication between the host computer and memory controller 76 may then be sent through powered host connector 72. The host computer may read or modify data that is stored in memory 78 as well as store new data or erase existing data. Memory controller 76 manipulates the data stored in memory 78 according to operations specified by the host computer.

Typically, the host computer provides a default amount of power upon insertion of host connector 72 to the host computer interface that is sufficient to enable memory device 70. Again, the default amount of power may be approximately 100 mA, for example. However, when a device is inserted into device socket 80, hub 74 must arbitrate with the host computer for additional power. The host computer may have an upper limit of power to allocate to the host computer interface, such as 500 mA in accordance with the USB standard.

If both memory device 70 and the device coupled to memory device 70 require more than the upper limit of power to operate properly, the power arbitration between hub 74 and the host computer will fail. In that case, hub 74 may trigger indicator 82 to alert a user that too much power is being requested at the host computer interface. Furthermore, hub 74 may disable device socket 80 so the user does not attempt to operate the underpowered device coupled to memory device 70.

Indicator 82 may comprise a light emitting diode (LED) or another element that can be made visible to a user to indicate insufficient power. In one embodiment, indicator 82 may remain off during normal operation of memory device 72 and turn on when triggered by hub 74 in response to receiving an insufficient amount of power. In another embodiment, indicator 82 may remain on during normal operation of memory device 72 and blink on and off when triggered by hub 74. In some embodiments, indicator 82 may display a first color during normal operation of memory device 70 and display a second color when triggered by hub 74.

Each of a plurality of memory devices substantially similar to memory device 70 may be connected to the host computer via the device socket included in the preceding memory device. As an example, up to five 100 mA memory devices may be coupled to the host computer that grants 500 mA of power through a single host computer interface. In that case, hub 74 included in memory device 70, the first memory device, arbitrates with the host computer to receive a sufficient amount of power to operate the subsequent memory devices connected downstream, e.g. the 500 mA. If the host computer allocates the upper limit of power to the first memory device, the four additional memory devices may also be powered. The fifth hub included in the fifth device determines that an insufficient amount of power is available to enable a sixth device inserted in the fifth device socket. The fifth hub triggers the fifth indicator included in the fifth device and may disable the fifth device socket.

FIG. 7 is a schematic diagram illustrating an exemplary embodiment of a memory device 84. Memory device 84 comprises a memory device housing 86, a host connector 88, host connector contacts 90 disposed on host connector 88, a cavity 92 formed in memory device housing 86, a device socket 94 disposed within cavity 92, and an indicator 96 disposed on memory device housing 86. FIG. 7 shows a top view of memory device 84. In the embodiment shown in FIG. 7, host connector 88 conforms to a USB plug and device socket 94 conforms to a USB receptacle. In other embodiments, host connector 88 and device socket 94 may conform to meet other host connection standards, such as the standards listed above.

Memory device 84 operates substantially similar to memory device 70 from FIG. 6. Memory device 84 may be connected to a host computer by inserting host connector 88 into a host computer interface included in the host computer. Host connector contacts 90 couple to contacts included in the host computer interface to allow power and data to flow between memory device 84 and the host computer.

A device, such as a mouse, a keyboard, or another memory device, may be connected to the host computer by inserting a connector included in the device to device socket 94 of memory device 84. Device socket 94 includes device socket contacts that couple to connector contacts disposed on the connector of the device. A hub (not shown) included in memory device 84 routes power and data between device socket 94 and the host computer.

If the host computer supplies an insufficient amount of power to the host computer interface to enable both memory device 84 and the device inserted into device socket 92, the hub within memory device 84 triggers indicator 96. Indicator 96 may comprise a LED. Indicator 96 alerts a user that too much power is being requested at the host computer interface.

In the embodiment illustrated in FIG. 7, memory device 84 comprises a memory drive, such as a flash memory drive. Again, flash memory drives include an internal, high-speed solid-state memory capable of persistently storing data without application of power. In addition, flash memory drives are compact, easy to use, and have no moving parts.

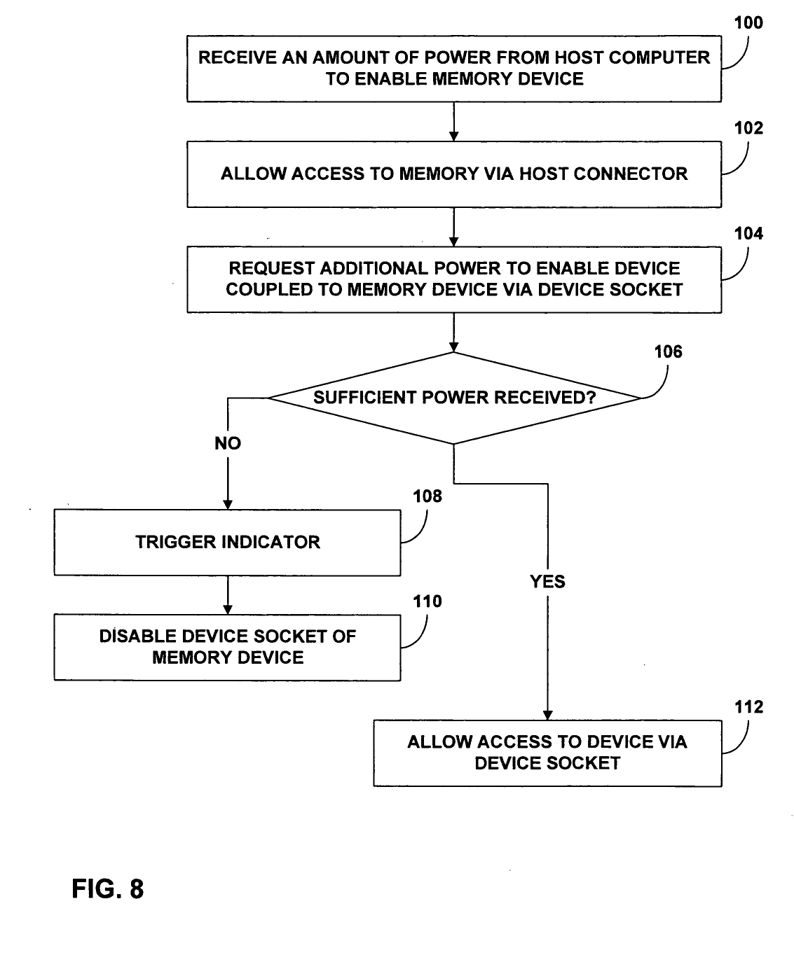

FIG. 8 is a flow chart illustrating an exemplary method of enabling a memory device with hub capability. The method may be applied to memory device 70 illustrated in FIG. 6. Memory device 70 couples to a host computer by inserting host connector 72 into a host computer interface included in the host computer. Memory device 70 also provides device socket 80 for a device, such as a mouse, a keyboard, or any other input device, or another memory device, to also couple to the host computer through memory device 70. In this way, memory device 70 integrates the functionality of a dual port hub into a conventional memory device. In an added embodiment, a memory device with a plurality of device sockets is also contemplated. In that case, the memory device which would include a multiple port hub and a plurality of additional devices could be coupled directly to the memory device via the multiple sockets.

Referring again to FIG. 8, upon insertion of host connector 72 to the host computer interface, memory device 70 receives an amount of power from the host computer to enable memory device 70 (100). In some cases, the amount of power received is a default amount of power provided to the host computer interface by the host computer. As an example, the amount of power received may be approximately 100 mA. Once memory device 70 receives the power from the host computer, hub 74 within memory device 70 allows the host computer access to memory 78 via host connector 72 and memory controller 76 (102). Communication between the host computer and memory controller 76 may then be sent through powered host connector 72. The host computer may read or modify data that is stored in memory 78 as well as store new data or erase existing data. Memory controller 76 manipulates the data stored in memory 78 according to operations specified by the host computer.

When a device is inserted in device socket 80 of memory device 70, hub 74 requests an amount of power to enable both memory device 70 and the device coupled to memory device 70 via device socket 80 (104). Hub 74 arbitrates with the host computer to receive power in addition to the amount of power received upon insertion of host connector 72 to the host computer interface. As an example, the host computer may provide up to 500 mA, i.e., 400 mA in addition to a default of 100 mA, to the host computer interface. Smaller increments of additional power may be alternatively provided. In any case, if memory device 70 and the device coupled to memory device 70 require more than an upper limit of power available to the host computer interface, the request for additional power will fail because sufficient power is not received (no branch of 106).

If sufficient power is not received (no branch of 106), hub 74 triggers indicator 82 included in memory device 70 (108). Indicator 82 alerts a user that an insufficient amount of power is provided to enable the device plugged into device socket 80 of memory device 70. Hub 74 also disables device socket 80 of memory device 70 (110). In that way, the user cannot attempt to use the device coupled to memory device 70 in an underpowered state. If the received power is sufficient (yes branch of 106), hub 74 allows the host computer access to the device via device socket 80 (112).

Various embodiments of the invention have been described. For example, a memory device has been described that includes a device socket and hub capability such that both the memory device and a device inserted in the device socket of the memory device may be simultaneously coupled to a host computer. Therefore, the memory device allows a plurality of devices to be coupled to the host computer through the same host computer interface included in the host computer. In addition, an indicator has been described that is triggered in response to the memory device receiving an insufficient amount of power to enable the device inserted in the device socket.

Nevertheless, various modifications may be made without departing from the scope of the invention. For example, the invention has been primarily described in terms of a USB memory drive including a USB device socket. Both the host connector and the device socket of the memory device may conform to a variety of host connection standards. The host connector and the device socket may conform to different host connection standards. Furthermore, the memory controller and the hub included in the memory device may be integrated as a single controller. The memory chips may also be integrated with the memory controller. Also, in an added embodiment, a memory device may include a plurality of sockets to receive a plurality of other devices. In that case, the memory device would include a multi-port hub that arbitrates power for each of the sockets. Each socket may include its own indicator to identify whether it has sufficient power to operate. These and other embodiments are within the scope of the following claims.

1. A memory device comprising:
a memory;
a hub electrically coupled to the memory;
a host connector electrically coupled to the hub and allowing access to the memory upon insertion of the host connector into a host computer interface; and
a device socket electrically coupled to the hub and allowing access to a device upon insertion of a connector included in the device into the device socket.

2. The memory device of claim 1, further comprising a memory controller, wherein the hub is electrically coupled to the memory via the memory controller.

3. The memory device of claim 2, wherein the host connector is electrically coupled to the hub via the memory controller.

4. The memory device of claim 1, wherein the host connector allows access to the memory via the hub.

5. The memory device of claim 1, wherein the device socket allows access to the device via the host connector and the hub.

6. The memory device of claim 1, further comprising an indicator electrically coupled to the hub, wherein the hub triggers the indicator when an amount of power received from the host computer is insufficient to power the memory device and the device.

7. The memory device of claim 6, wherein the indicator comprises a light emitting diode (LED).

8. The memory device of claim 1, wherein the hub disables the device socket when an amount of power received from the host computer is insufficient to power the memory device and the device.

9. The memory device of claim 1, wherein the host connector conforms to a host connection standard and the host computer interface is compatible with the host connection standard.

10. The memory device of claim 9, wherein the device socket is compatible with the host connection standard and wherein the connector included in the device conforms to the host connection standard.

11. The memory device of claim 9, wherein the host connection standard comprises one of a Universal Serial Bus (USB) standard and a Universal Serial Bus 2 (USB2) standard.

12. A system comprising:
a host computer including a host computer interface;
a device including a connector; and
a memory device including:
a memory,
a hub electrically coupled to the memory,
a host connector electrically coupled to the hub and allowing access to the memory upon insertion of the host connector into the host computer interface of the host computer, and
a device socket electrically coupled to the hub and allowing access to the device upon insertion of the connector of the device into the device socket of the memory device.

13. The system of claim 12, wherein the memory device comprises a first memory device and the device socket comprises a first device socket, and wherein the device comprises a second memory device and the connector comprises a second host connector, the second memory device further including:
a second memory;
a second hub electrically coupled to the second memory and to the second host connector, the second host connector allowing access to the second memory upon insertion of the second host connector into the first device socket; and
a second device socket electrically coupled to the second hub and allowing access to another device upon insertion of another connector included in the another device into the second device socket.

14. The system of claim 13, wherein the another device comprises a third memory device and the another connector comprises a third host connector.

15. The system of claim 12, wherein the device comprises one of a mouse, a keyboard, a joystick, a scanner, a printer, a game controller, a docking station for a handheld computer, a portable digital assistant (PDA), a digital still camera, a digital video camera, a cell phone, another hub, a digital music player, a digital multimedia player, and a memory drive.

16. A method comprising:
receiving an amount of power from a host computer to enable operation of a memory device upon insertion of a host connector of the memory device into a host computer interface of the host computer;
allowing access to a memory within the memory device via the host computer upon insertion of the host connector into the host computer interface; and
allowing access to another device by the host computer through the memory device upon insertion of a connector of the another device into a device socket of the memory device.

17. The method of claim 16, wherein the memory device comprises a first memory device and the another device comprises a second memory device, and wherein allowing access to the another device comprises allowing access to a second memory included in the second memory device.

18. The method of claim 16 further comprising:
requesting an amount of power from a host computer to enable operation of the memory device and the another device coupled to the memory device; and
triggering an indicator included in the memory device when an amount of power received from the host computer is insufficient to power both the memory device and the another device coupled to the memory device.

19. The method of claim 16, further comprising enabling access to the another device by the host computer through the memory device when the power received from the host computer is sufficient to power both the memory device and the another device coupled to the memory device.

20. The method of claim 16, further comprising disabling access to the another device by the host computer through the memory device when the power received from the host device is insufficient to power both the memory device and the another device coupled to the memory device.
